(19) United States
(12) Patent Application Publication
(10) Pub. No.: US 2005/0140696 A1
(43) Pub. Date: Jun. 30, 2005

(54) Split user interface

(76) Inventor: William Arthur Stewart Buxton, Toronto (CA)

Correspondence Address: STAAS & HALSEY LLP, SUITE 700, 1201 NEW YORK AVENUE, N.W., WASHINGTON, DC, 20005, US

(21) Appl. No.: 10/748,683

(22) Filed: Dec. 31, 2003

(51) Int. Cl. G09G 5/00

(52) U.S. Cl. 345/660

(57) ABSTRACT

A system with a graphical user interface displayed on a display. The graphical user interface may have a first interface element and a second interface element. The first interface element may be automatically reoriented relative to the display in accordance with a change to orientation/location information that corresponds to a change to a spatial orientation/location relative to the display. The second interface element may be allowed to remain in a same orientation relative to the display regardless of or independent of the change to the orientation/location relative to the display. One or more elements may orient to one or more different users.

### CROSS-REFERENCE TO RELATED APPLICATION

This application is related to U.S. application entitled “SYSTEM FOR MAINTAINING ORIENTATION OF A USER INTERFACE AS A DISPLAY CHANGES ORIENTATION”having Ser. No. 10/233,679, by Buxton et al., filed Sep. 4, 2002, and incorporated by reference herein.

### BACKGROUND OF THE INVENTION

1. Field of the Invention

The present invention is directed to a system allowing different portions or parts of a user interface to respond differently to changes in orientation/location information and, more particularly, to a system where the orientation/location information corresponds to an actual physical orientation/location possibly relative to a display displaying the user interface, and one or more user interface elements are oriented relative to the orientation/location information and one or more other user interface elements are not relatively oriented but rather stay fixed with respect to the user interface and/or the display displaying the user interface.

2. Description of the Related Art

User orientations in user interfaces have been limited. As discussed in U.S. application Ser. No. 10/233,679, artists typically do not leave their drawing or sculpture in a static position when creating it. Human biomechanics make some drawing gestures easier than others. Hence, the artist will shift and/or rotate the artwork on the desktop to facilitate drawing. For example, the artist might rotate the drawing into a sideways position so that a downward stroke can be used in a horizontal direction of an animation cell. This type of manipulation of the artwork has been impractical with the computer-implemented visual arts. It is known to relate a displayed subject or model, and a display which are relatively rotating while a user orientation stays oriented to a user rotating the display. However, some user interface elements may require orientation, and some may not. Other mechanisms for driving orientation are also needed.

What is needed is a system that will allow user interface elements to be oriented according to orientation/location information on an element-by-element basis.

It is known that a display may be rotated, where the rotation of the display is sensed, and the sensed rotation can then change the user orientation used for interface-related orientation. However, other techniques for obtaining a user orientation are possible.

What is needed is a system able to use different techniques to determine a use orientation/location or orientation/location information that is used to orient one or more user interface elements.

It is known that multiple users each use their own interface or interface elements, and the interface elements or inputs directed thereto are oriented according to the current orientation and the current user.

What is needed is a system that allows different users to have their own user interface elements or shared interface elements, where the elements may be oriented on an element-by-element basis, and where different techniques may be used to determine the orientation.

It is known to change a user interface orientation continuously to match continuous changes in spatial orientation or rotation of a display.

What is needed is a system that allows a user interface (or a part thereof) to jump to a new orientation while another portion of the user interface stays fixed or does not reorient with respect to the user interface or a display displaying the same.

### SUMMARY OF THE INVENTION

It is an aspect of the present invention to provide a system that will allow user interface elements to be oriented according to orientation/location information on an element-by-element basis.

It is another aspect of the present invention to provide a system that is able to use different techniques to determine a use orientation or orientation/location information that is used to orient one or more user interface elements.

It is yet another aspect of the present invention to provide a system with a user interface that automatically senses or receives explicitly inputted orientation information and orients at least one or more (but not necessarily all) elements of the interface based on the same.

It is a further aspect of the present invention to automatically sense orientation based on the direction of a stylus, or based on a direction from which an input device enters an input area, or based on an orientation of a special orienting mark or gesture, or based on rotation of a display, or based on image or sound processing, or based on an identity of a user which in turn may be automatically or interactively determined.

It is still another aspect of the present invention to provide a system that allows different users to have their own user interface elements, where the elements may be oriented on an element-by-element basis, and where different techniques may be used to determine the orientation.

It is another aspect of the present invention to allow a user interface element to jump to a new orientation while another portion of the user interface stays fixed or does not reorient within the user interface, where an orientation jump may be from a user at one orientation to one or more other users at other orientations, or may be from one incremental user orientation to another, or combinations thereof.

It is yet another aspect of the present invention to provide multiple subsets of the user interface which may be oriented to multiple users.

The above aspects can be attained by a system with a graphical user interface displayed on a display. The graphical user interface may have a first interface element and a second interface element. The first interface element may be automatically reoriented relative to the display in accordance with a change to orientation/location information that corresponds to a change to a spatial orientation/location relative to the display. The second interface element may be allowed to remain in a same orientation relative to the display or user interface regardless of or independent of the change to the orientation/location relative to the display. The second element may also reorient by a different rate or style, for example the first part of a user interface orients continuously as the display is turned and the second part orients only after the display is turned at least 90 degrees. These, together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a graphical user interface 20 displayed on a display 21.

FIG. 2 shows a gimbaled interface element 22 oriented to user 30 after rotation of the display 21 and interface 20.

FIG. 3 shows an orienting process.

FIG. 4 shows a process for orienting one or elements in a multi-user setting.

FIG. 5 shows another process for orienting one or elements in a multi-user setting.

FIG. 6 shows an example of a sequence of orientations with multiple users.

FIG. 7 shows another aspect of a split interface.

### DETAILED DESCRIPTION OF THE PREFERRED EMBODIMENTS

An aspect of the present invention is directed to a system with a graphical user interface displayed on a display. The graphical user interface may have a first interface element and a second interface element. The first interface element may be automatically reoriented relative to the display in accordance with a change to orientation/location information that corresponds to a change to a spatial orientation/location relative to the display. The second interface element may be allowed to remain in a same orientation relative to the display regardless of or independent of the change to the orientation/location relative to the display. One or more elements may orient to one or more different users.

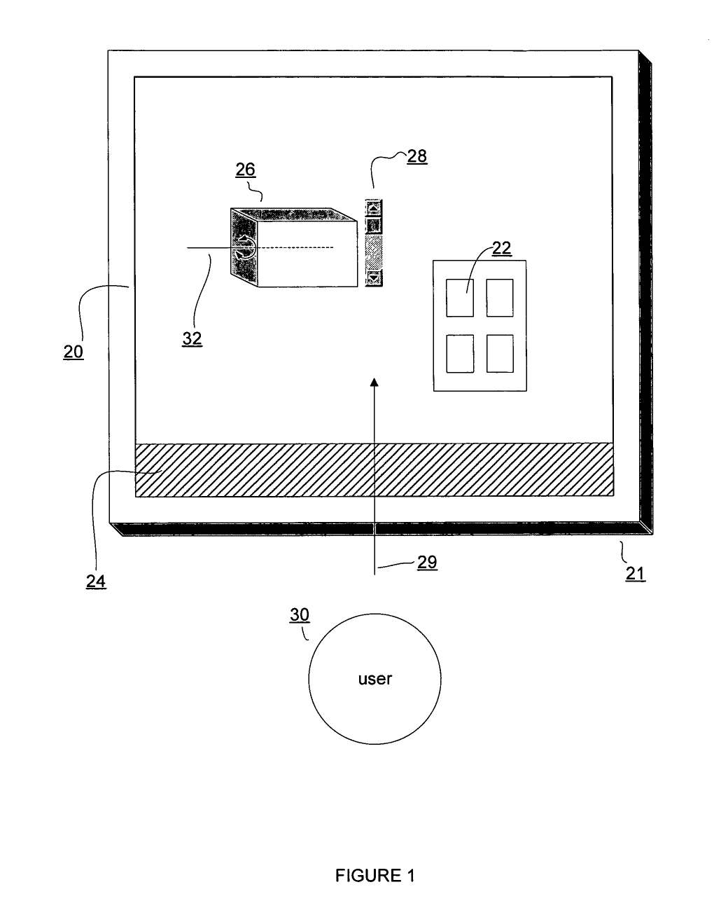

FIG. 1 shows a graphical user interface 20 displayed on a display 21. The graphical interface 20 has interface elements 22, 24, 26, and 28. Interface element 20 is a gimbaled widget or interface element 22, which is oriented according to current use orientation 29. Interface element 24 is, for example, a taskbar that is generally fixed or statically arranged with respect to the user interface 20 or display thereof. That is, it does not gimbal or reorient with changes in user or spatial orientation as does gimbaled element 22. Interface element 26 is a model or subject 26, which has an associated interface element 28, such as a scrollbar 28 that can be interactively used to control the view of the subject 26. The subject 26 is typically a workpiece or the like being edited or viewed by a user 30. The scrollbar 28 can be used, for example, to tumble or rotate the subject 26 about axis 32.

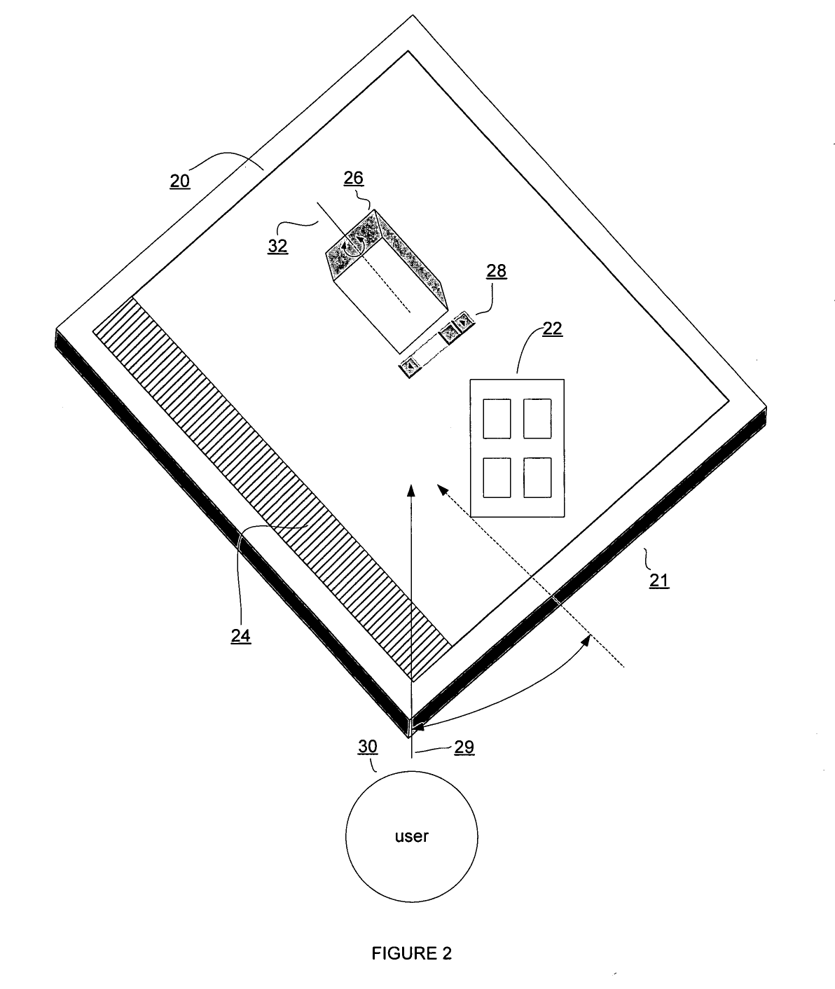

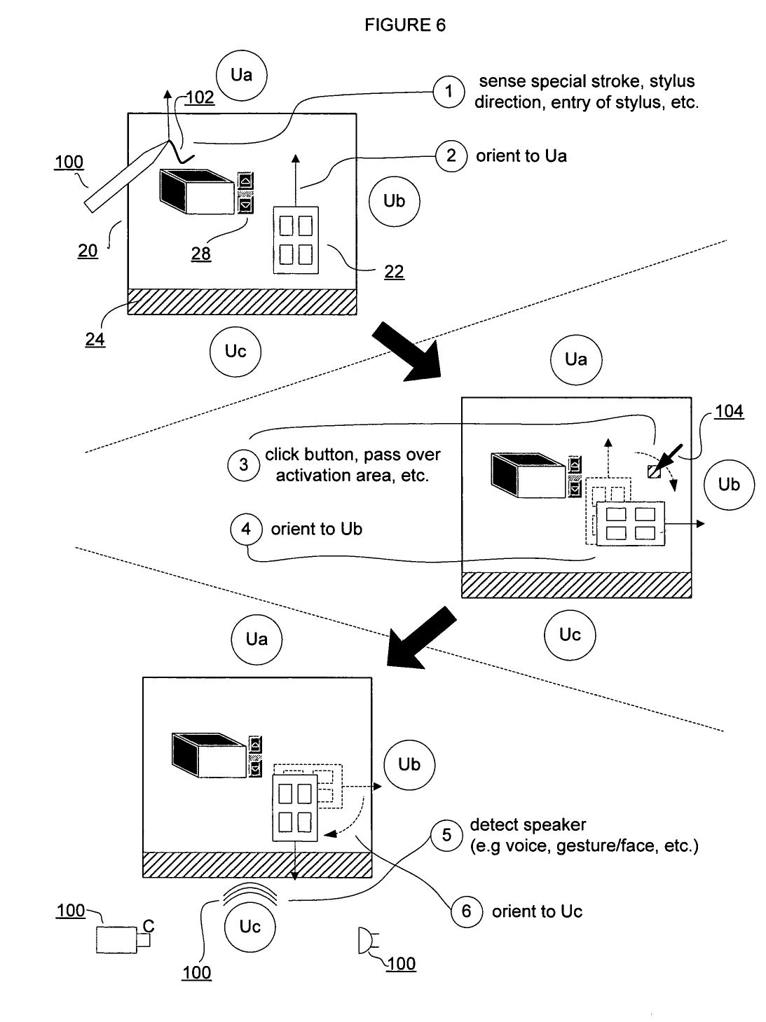

FIG. 2 shows a gimbaled interface element 22 oriented to user 30 after rotation of the display 21 and interface 20. U.S. patent application Ser. No. 10/223,679 provides detail on how to gimbal an interface or interface element so that it stays oriented to a user or spatial orientation/location when a display rotates relative to the user, or when a user viewpoint changes relative to the display. The same patent application provides detail on how to allow a model or subject to stay fixed with respect to the display while the display and viewpoint rotate relative to each other. Therefore, it is understood how this behavior can be provided for the elements 22 and 26 of interface 20. Furthermore, it is possible for use orientation 29 to be obtained by movement of or movement by the user 30, rather than by rotation of the display 21. For example, a camera or microphone could determine the location of the user 30 relative to the display (see FIG. 6). Or, the direction of an input device such as a stylus can change, which is possible to detect using a pressure sensitive pad available for example from the Wacom Technology Co.

Some user interface elements require orientation relative to input that operates the element. For example, a marking menu may use the direction of a mouse/pointer stroke to activate a menu item or operation. Thus, a user facing the upper edge of a display would be operating the marking menu upside down if the marking menu (or the input directed to it) were not oriented to take into account the position of the user relative to the user interface and the marking element thereof. Some interface elements benefit from or require orientation of their display relative to a user. For example, text can be difficult to read when it is upside down. Therefore, text is another user interface element that benefits from orientation relative to a user.

In some instances, it is preferable to not orient (or allow to remain fixedly oriented relative to the user interface) some interface elements. With some user interfaces, some interface elements thereof are outside the scope of a user application and are difficult to reorient therewith. Such interface elements may be in the domain of a window manager, user shell, operating system, or another computer (e.g. a remotely hosted but locally displayed widget). For example, it may be inconvenient or difficult for a user application to gimbal the Microsoft Windows taskbar. Furthermore, it is the observation of the inventor that with some interface elements, gimbaling or reorienting to a user may not be desirable. Consider the scrollbar 28 shown in FIGS. 1 and 2.

The scrollbar 28 might tumble, darken/lighten, shrink/enlarge, or otherwise operate upon the subject model 26. In the case of tumbling, if the subject 26 is not gimbaled, as in U.S. patent application Ser. No. 10/223,679, then it is not desirable to gimbal the scrollbar 28. Rather than orienting the scrollbar 28 to a frame of reference such as a user, user viewpoint, spatial orientation/location, etc., it is preferable to orient the scrollbar 28 with respect to the subject 26. Therefore, if display 21 is rotated from a first user to a second user, and the image of the subject model 26 physically rotates with the display 21 (staying fixed with respect to the interface 20), then scrollbar 28 should preferably also stay fixed with respect to the interface 20. The scrollbar 28 does not have or require a use orientation such as “up” or “down” and it can be intuitively operated at any orientation relative to a user. In other words, it can be beneficial to alter the orientation, relative to the user, of the display 21 displaying the subject 26 and the interface element scrollbar 28. This allows for an orient-less element or for an element of local interest to continue to operate locally, independent of or without regard for the gimbal-to frame of reference (e.g. the display, the user, etc.).

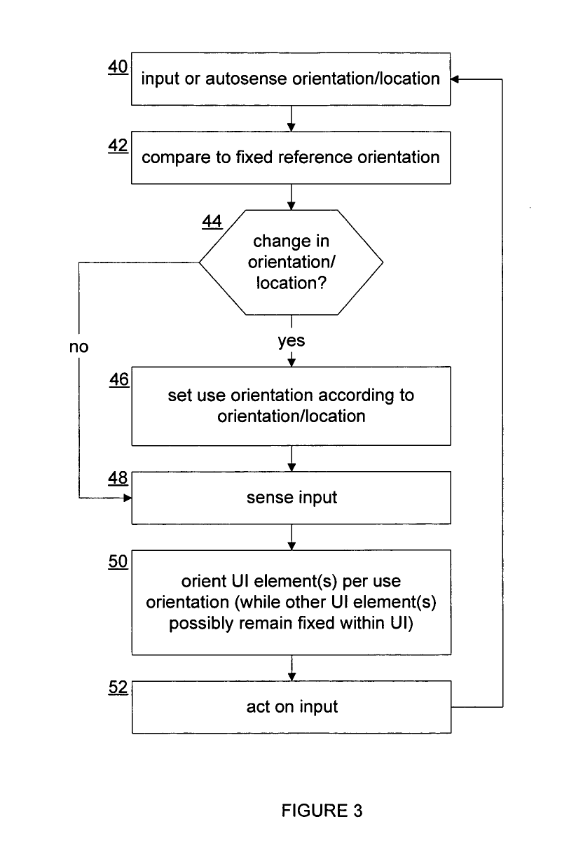

FIG. 3 shows an orienting process. Information of a current real world or spatial orientation/location (either absolute or relative) is inputted or auto-sensed 40. For example, an orientation of the display 21 can be read by sampling an orientation sensor coupled to the display 21. A pressure sensitive input surface, available for example from Wacom Technology Co., can be used to detect the orientation of a grasped stylus that is being used to operate or interact with the user interface, and the orientation of the stylus can serve as a basis for the inputted or auto-sensed 40 orientation/location information. An audio or visual input device, such as a camera or microphone, can be used to determine or auto-sense 40 the location/orientation of a user relative to a display of the user interface. It is also possible for a user to explicitly input or indicate their current orientation/location. For example, a pie-shaped widget with a fixed orientation relative to the user interface can be provided, where different quadrants or slices of the widget, correspond to different orientation/locations. When a user selects a particular slice, the direction of the selected slice determines the current orientation/location of the user. Segments of a ring can be similarly used. For example, a tool palette, radial menu, etc. can be provided with a ring and then reoriented according to selection of a point or segment on the ring, where the selection by convention indicates the user's current “up”, “down”, etc. It is also possible to explicitly input orientation/location information by using a special predetermined stroke, symbol, or gesture, for example an upside-down “Y”. When a user draws the upside-down “Y”, the symbol is automatically recognized as the predefined orienting symbol, and the direction of the upside-down “Y” relative to the user interface serves as a basis for the orientation/location information. It is also possible to use a combination of auto-sensing and explicit inputting. For example, a speaker could command the interface to reorient using predetermined speech commands, such as “turn left”, “flip”, “orient three o'clock”, etc. A speech recognition unit would recognize the orientation command and the orientation/location information would be set accordingly.

Referring again to FIG. 3, after the orientation/location information has been inputted or auto-sensed, the information is compared 42 to a fixed reference orientation. If 44 there is a change in orientation/location, then a use orientation is set 46 according to the orientation/location information (or change thereto). Otherwise, user input such as a stroke is sensed 48, and then one or more user interface elements are oriented according to the user orientation while one or more other user interface elements remain fixed within or with respect to the user interface. The user input can be oriented according to the orientation/location information rather than orienting 50 the user interface elements. It is also possible that no input will be sensed 48, as for example when the user interface elements are being oriented for display. Finally, the input is acted on 52. Additional explanation of how to relatively orient a user interface element and input directed to the same may be found in U.S. patent application Ser. No. 10/233,679.

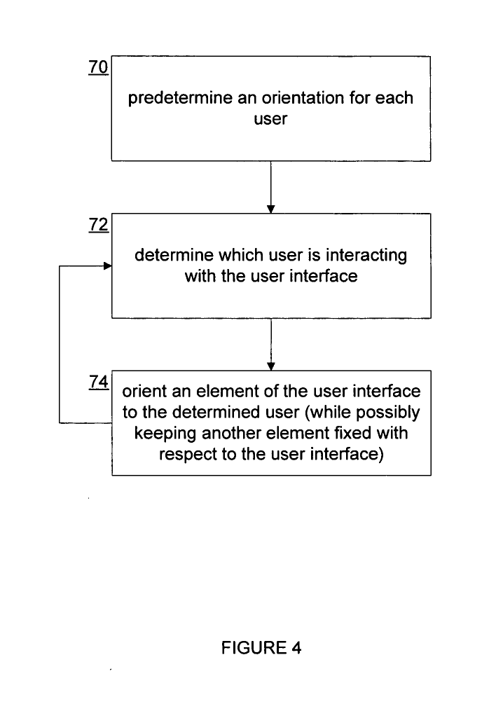

FIG. 4 shows a process for orienting one or more elements in a multi-user setting. Often multiple users desire to view or operate a user interface at the same time and place. For example, three users may sit around a display laid flat on a table (see FIG. 6), where the display is displaying a user interface. The users may each wish to operate the use interface. By taking turns, each user may draw on the display, drag an interface element, scroll a document, operate a menu, rotate a model, etc. (note, simultaneous multiple control and orientations are also possible). As shown in FIG. 4, one way of orienting user interface elements in a multi-user setting is to first predetermine 70 an orientation for each user. For example, by inputting a direction with each user (user Ua=north, user Ub=south, user Uc=southwest, etc.). Which user is interacting with the user interface (or otherwise needs orienting) is then determined 72. Finally, one or more elements of the user interface are oriented to the predetermined user according to the user's predetermined orientation. Other interface elements may remain fixed with respect to the user interface. The process of FIG. 4 allows an interface element to jump from one user orientation to another without requiring continuous changes to a user orientation. A user's identity may be determined by any number of well known techniques, including for example a type of stylus, voice recognition, image recognition, proximity to a previous location, type of stylus or input device, individual stylus pressure profile, etc.

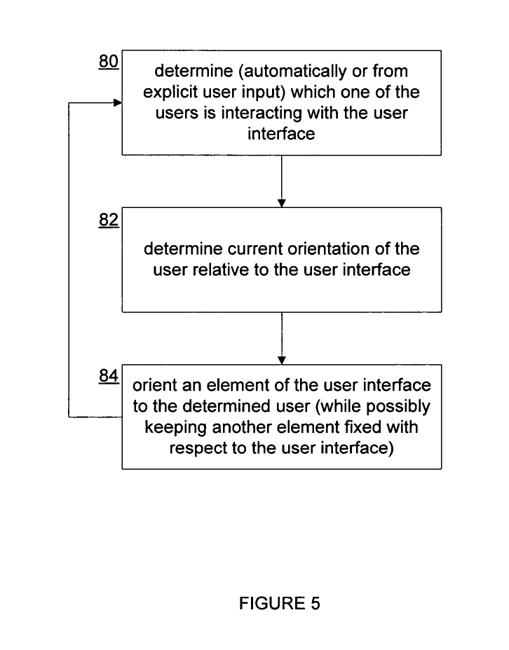

FIG. 5 shows another process for orienting one or more elements in a multi-user setting. First, the identity of one of the users is determined 80. Then, the current orientation of the user relative to the user interface is determined 82. Then, one or more elements of the user interface are oriented 84 according to the current orientation of the current user. In the multi-user context, each user may have their own interface elements that are oriented to them, or one or more shared elements may be oriented as needed.

FIG. 6 shows an example of a sequence of orientations with multiple users. The users are Ua, Ub, and Uc. First, orientation/location information is determined by the direction of a stylus 100 (possibly determined by the angle of the stylus) or the direction of a special gesture or stroke 102 made with the stylus 100. Second, the interface element 22 is oriented to user Ua according to the determined direction. User Ua could operate the scrollbar 28, the interface element 22, taskbar 24, and so on, until another user takes over. Third, user Ub performs an action, such as clicking a button 103 with a pointer 104, passing the pointer 104 over an activation area, etc. The button click identifies the user as Ub. Fourth, the interface element 22 reorients to the identified user Ub, using either predetermined or dynamic orientation/location information. Fifth, the system automatically identifies user Uc, using a microphone 104 and voice recognition processing, or using a camera 106 and image recognition processing. Sixth, the interface element 22 orients to user Uc, according to either a predetermined orientation/location of Uc, or according to an auto-detected orientation/location, for example using microphone 104 or camera 106. Throughout each reorientation, one or more interface elements, such as taskbar 24 and scrollbar 28 remain fixed with respect to the interface 20. A similar sequence may also occur when the displayed interface 20 physically rotates (as with rotation of its display) to different of the users.

In the case of multiple users, multiple subsets of the user interface may be oriented to multiple users. For example, 3 users seated around a large round table top display may orient different sets of windows to each of their individual viewpoints. Also, as used herein, orientation to a user refers to orientation relative to a user, and does not require orientation towards the user. That is to say, orientation does not have to be towards a user. For example, a single user could turn items they are not interested in upsidedown to “mark” them as uninteresting.

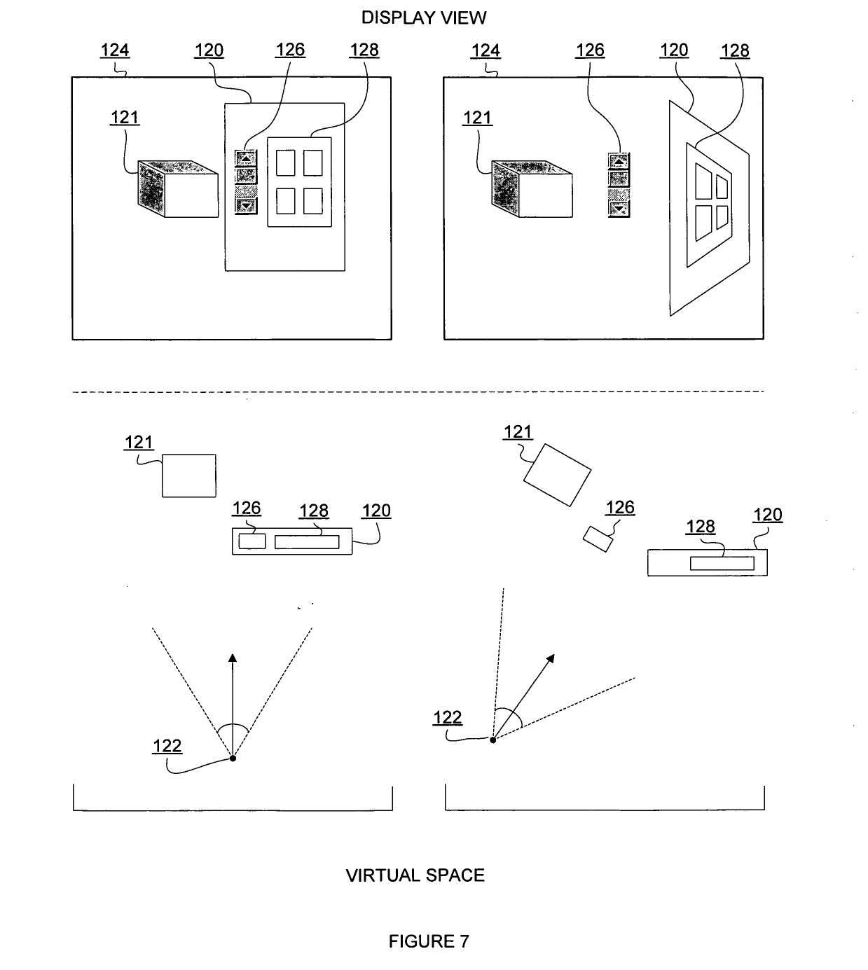

FIG. 7 shows another aspect of a split interface. A sub-interface or interface 120 and model 121 are shown on a display 124 as virtually seen from a first orientation or viewpoint 122. Two interface parts 126 and 128 are shown as part of the same interface 120. When the viewpoint 122 changes to a second orientation or viewpoint 130, for example to match a new real-space orientation/location, interface parts 126 and 128 “separate”. Thus, in the view for the second viewpoint 130, the sub-interface or interface 120 has split. In other words, a change in real-space orientation/location results in only a portion of the interface 120 rotating relative to the display (i.e. staying oriented with respect to a real-space frame of reference). The effect may be understood with reference to a virtual camera being maneuvered around a model. Suppose a movable display moves the virtual camera as a kind of virtual window onto a model, thus allowing the model to be viewed from different viewpoints. Some virtual user interface elements may stay fixed with respect to the model, and manipulation of the display about the model results in such interface elements entering or exiting the currently displayed interface. For example, if the viewpoint in FIG. 7 were swung far enough clockwise, the interface 120 and part 128 would no longer be shown on the display 124.

The present invention has been described with respect to a system with a graphical user interface displayed on a display. The graphical user interface may have a first interface element and a second interface element. The first interface element may be automatically reoriented relative to the display in accordance with a change to orientation/location information that corresponds to a change to a spatial orientation/location relative to the display. The second interface element may be allowed to remain in a same orientation relative to the display regardless of or independent of the change to the orientation/location relative to the display.

In another embodiment, more than two users may be accounted for. Also, multiple subsets of the user interface may be able to be oriented to multiple users. For example, 3 users seated around a large round table top display may orient different sets of windows to each of their individual viewpoints. Also, orientation does not have to towards a user: for example, a single user could turn items they are not interested in upsidedown to “mark” them as uninteresting.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A graphical user interface displayed on a display and comprising a first part and a second part, the method comprising:
the first part element is automatically reoriented relative to the display in accordance with a change to orientation/location information; and
allowing the second interface part is allowed to remain in a same orientation relative to the display regardless of the change to the orientation/location information.

2. A method according to claim 2, wherein the first part is a first user interface element and the second part is a second user interface element.

3. A method according to claim 2, wherein a user explicitly determines the change to the orientation/location information.

4. A method according to claim 3, wherein the explicit determination comprises the user interactively inputting information that indicates an orientation.

5. A method according to claim 2, wherein the change to the orientation/location information is determined automatically based on a spatial orientation/location change relative to the display.

6. A method according to claim 5, wherein the automatic determination comprises at least one of sensing the orientation of an input device, sensing the orientation/location of a user, automatically identifying an identify of a user.

7. A method for setting a use orientation of a user interface displayed on a display, where the use orientation the determines orientation of the display of or interaction with one or more interface elements of the user interface relative to the display, the method comprising:
receiving orientation/location information corresponding to a spatial orientation/location;
changing the use orientation according to the orientation/location information; and
with respect to display of or interaction with another element of the user interface, ignoring or not responding to the changing of the use orientation.

8. A method according to claim 7,
wherein the one or more interface elements oriented by the use orientation comprise at least one of a marking menu, a menu, a scrollbar, a tool palette, a pie menu, a gesture widget, a toolbar, and text; and
wherein the other element of the user interface comprises at least one of a menu, a scrollbar, a taskbar, an element of a user shell, an element of a window manager, and an orient-less element.

9. A method, comprising:
automatically determining an orientation of a user relative to a display displaying a user interface; and
automatically orienting an element of the user interface to the user, where another element of the user interface is fixed relative to the user interface both before and after the orienting.

10. A method, comprising:
interactively inputting orientation/location information representing an orientation/location of a user relative to a display displaying a user interface; and
automatically orienting an element of the user interface to the user according to the inputted orientation/location information.

11. A method according to claim 10, wherein another element of the user interface is fixed relative to the user interface both before and after the orienting.

12. A method according to claim 10, wherein orienting further comprises orienting user input relative to the element.

13. A method of orienting elements of a user interface used by a plurality of users, the method comprising:
determining either automatically or explicitly which one of the users is controlling or interacting with the user interface; and
automatically orienting an element of the user interface relative to the determined user.

14. A method according to claim 13, further comprising:
automatically determining that another of the users is controlling or interacting with the user interface; and
automatically orienting the element of the user interface relative to the other determined user.

15. A method according to claim 14, wherein at least one other element of the user interface stays fixed within the user interface in spite of the orientings of the element.

16. A method according to claim 13, wherein each user has a subset of interface elements for orientation.

17. A method according to claim 16, wherein the two user interface element subsets have one or more common elements.

18. A method for setting a use orientation of a user interface displayed on a display, where the use orientation determines orientation of the display of or interaction with one or more interface elements of the user interface relative to the display, the method comprising:
receiving user information identifying a first user or a second user;
changing the use orientation to a first value when the user information identifies the first user;
changing the use orientation to a second value when the user information identifies the second user; and
with respect to display of or interaction with another element of the user interface, ignoring or not responding to the changing of the use orientation.

19. A method according to claim 18,
wherein the one or more interface elements oriented by the user orientation comprise at least one of a marking menu, a menu, a scrollbar, a tool palette, a pie menu, a gesture widget, a toolbar, a graphics display widget, text, and a model or subject to be displayed and interactively edited; and
wherein the other element of the user interface comprises at least one of a marking menu, a menu, a scrollbar, a tool palette, a pie menu, a gesture widget, a toolbar, a graphics display widget, text, a model or subject to be displayed and interactively edited, an element of a user shell, an element of a window manager, and an element that is not part of a user application.

20. An apparatus, comprising:
a display mapped to a user interface element having a use orientation; and
a processor adjusting the use orientation of the user interface element in response to a change to a spatial orientation of a viewpoint, where the use orientation remains fixed with respect to a user orientation reference when the spatial orientation of the viewpoint has changed with respect to the user orientation reference, and the adjusting of the use orientation and the change to the spatial orientation do not affect display of or interaction with another user interface element.

21. An apparatus, comprising:
a display allowing one or more interface elements to change orientation corresponding to a change in orientation of said display with respect to a user orientation reference while one or more other interface elements remain in a fixed orientation with respect to the user orientation reference.

22. An apparatus according to claim 21, wherein another interface element, that changes orientation corresponding to the change in orientation of said display with respect to the user orientation reference, comprises an interface control widget.

23. A graphical user interface displayed on a display and comprising a first interface element and a second interface element, the graphical interface comprising:
the first interface element which is automatically reoriented relative to the display in accordance with a change to orientation/location information; and
the second interface element is allowed to remain in a same orientation relative to the display regardless of the change to the orientation/location information.
